(19) United States
(12) Patent Application Publication
(10) Pub. No.: US 2023/0049609 A1
(43) Pub. Date: Feb. 16, 2023

(54) ASSEMBLY AND METHOD FOR PROCESSING VISCOUS MATERIAL

(71) Applicant: NEXXUS CHANNEL S.R.L., Gemonio (VA) (IT)

(72) Inventor: Giuseppe Ponzielli, Cittiglio (VA) (IT)

(21) Appl. No.: 17/785,667

(22) PCT Filed: Dec. 16, 2020
(86) PCT No.: PCT/IB2020/062050

§ 371 Date: Jun. 15, 2022

(30) Foreign Application Priority Data
Dec. 16, 2019 (IT) 102019000024114

(51) Int. Cl. B01F 27/272; B01F 27/724; B01F 33/82; B01F 23/47; B01F 23/43

(52) U.S. Cl. CPC B01F 27/2721; B01F 27/2722; B01F 27/724; B01F 33/82; B01F 23/47; B01F 23/43; B01F 2101/2805

(57) ABSTRACT

An assembly for processing viscous material comprises a process duct extending along a longitudinal axis, wherein viscous material advances in one advancing direction, at least one pumping device provided with a stator comprising a cylindrical seat, and at least one cylindrical rotor. The at least one cylindrical rotor is housed in the stator and is coupled to the stator with a sliding seal. The rotor rotates around a rotating axis substantially parallel to the longitudinal axis and has an outer face with at least one groove, which forms with the inner surface of the stator one pumping channel. The pumping device is configured so that the pumping channel extends between at least one inlet and at least one outlet and the inlet and the outlet are in fluid connection with the process duct.

### CROSS-REFERENCE TO RELATED APPLICATIONS

This patent application claims priority from Italian patent application no. 102019000024114 filed on Dec. 16, 2019, the entire disclosure of which is incorporated herein by reference.

### TECHNICAL FIELD

The present invention relates to an assembly for processing viscous material.

In particular, the present invention is particularly suitable for processing substantially liquid viscous material.

### BACKGROUND ART

In machines for processing viscous liquids in continuous mode, such as for example a screw extruder, it is particularly useful to “thin” the volume of the treated liquid, in order to transform it into an equivalent volume with a lower thickness and a greater surface extension. In other words, in a volume having x, y, z coordinates, the thinning entails increasing the surface extension of the x-y or x-z or z-y planes respectively with respect to the z or y or x dimension.

The thinning described above is particularly useful in some applications such as, for example:
the incorporation of fillers in the form of fine powder;
degassing in the atmosphere or under vacuum for the elimination of volatile residues such as monomeric substances, solvents, water vapor, odours, etc.;
mixing of incompatible liquids;
molecular re-gradation (or molecular extension), for example for post-condensation polymers such as for example Polyethylene Terephthalate PET, Polyamide PA, Polycarbonate PC, etc.

In all the four examples cited above, it is very useful for the material to be transformed into a thin film, with a defined and constant thickness, for example ranging between 1 micron and 5000 microns. The lower the film thickness, the faster the above processes take place.

Documents GB 2007585 and U.S. Pat. No. 4,606,646 describe machines for degassing viscous liquids. However, the solutions described in these documents have limitations in terms of efficiency and speed of the process.

Documents WO 2019/049077, GB 1592261 and U.S. Pat. No. 4,227,816 are also known, which describe machines for processing viscous material that are equipped with a material inlet from above and with an outlet spaced from the inlet by about ⅔ of circumference. Said machines do not achieve the desired incorporation effect and can be hardly combined with existing processors.

### DISCLOSURE OF INVENTION

It is therefore an object of the present invention to provide an assembly for processing viscous material which is free from the drawbacks of the prior art.

In particular, it is an object of the present invention to provide an assembly for processing viscous material which is efficient and, at the same time, easy and economical to realise.

In accordance with these purposes, the present invention relates to an assembly for processing viscous material according to claim 1.

Thanks to the connection between the process duct and the pumping duct, at least a part of the viscous material is subjected to at least one passage in the pumping channel. This determines an increase in the interface surface and therefore an optimisation of the process to which the material is subjected.

It is also an object of the present invention to provide a method for processing viscous material as claimed in claim 15.

### BRIEF DESCRIPTION OF THE DRAWINGS

Further characteristics and advantages of the present invention will become clear from the following description of a non-limiting example of an embodiment thereof, with reference to the figures of the attached drawings, in which:

FIG. 1 is an exploded perspective schematic representation, with parts removed for clarity's sake, of the assembly for processing material according to the present invention;

FIG. 2 is a schematic bottom view, with parts removed for clarity's sake, of a first detail of the assembly of FIG. 1;

FIG. 3 is a schematic sectional view along the plane III-III of the assembly of FIG. 1;

FIG. 4 is a schematic sectional view along the plane IV-IV indicated in FIG. 1 of a second detail of the assembly of FIG. 1;

FIG. 5 is a schematic sectional view along the plane V-V of the assembly of FIG. 1;

FIG. 6 is a schematic sectional view, with parts removed for clarity's sake, of an assembly for processing viscous material in accordance with a variant of the present invention;

FIG. 7 is a schematic side view of a further variant of the assembly for processing viscous material according to the present invention;

FIG. 8 is a schematic sectional view, with parts removed for clarity's sake, of the assembly for processing viscous material according to the variant of FIG. 6.

### BEST MODE FOR CARRYING OUT THE INVENTION

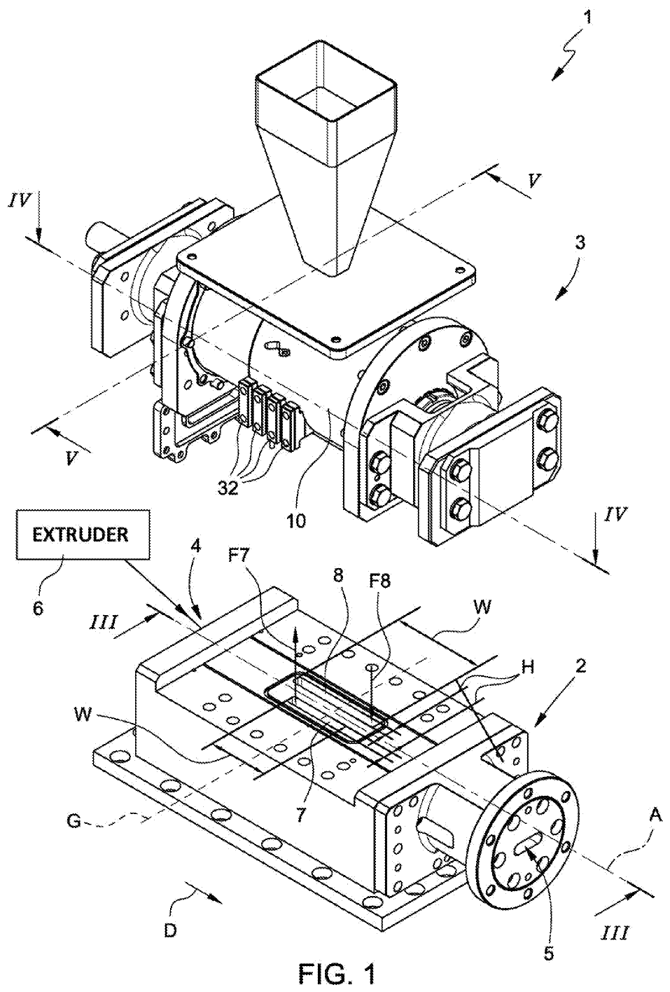

In FIG. 1, the reference number 1 denotes an assembly for processing viscous material according to the present invention.

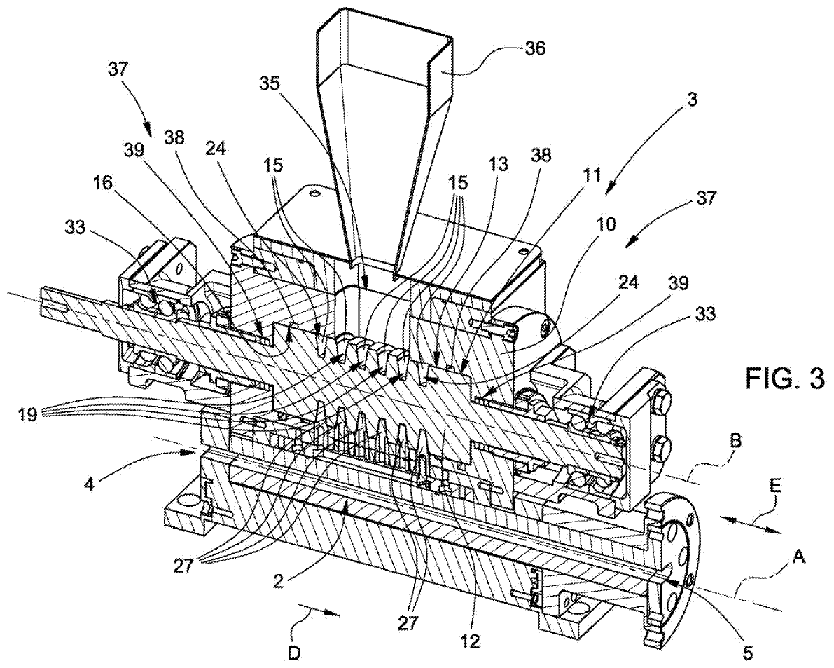

The assembly 1 comprises a process duct 2 and a pumping device 3, which, in use, are coupled together (see FIG. 3).

The process duct 2 (better visible in FIG. 3) extends along a longitudinal axis A between an inlet 4 and an outlet 5.

In use, the process duct 2 is fed with viscous material, as we will see in detail below, for example from a screw extruder 6. In the process duct 2, the viscous material advances in one advancing direction D.

In the non-limiting example described and shown herein, the process duct 2 has a substantially rectangular flow section.

Preferably, the section of the process duct 2 is constant.

It is understood that the process duct 2 may have a different section, for example circular or for example with a double lobe.

The process duct 2 has an opening 7 and an opening 8, through which the process duct 2 is in communication with the pumping device 3.

Preferably, the opening 7 and the opening 8 are arranged side by side. In the non-limiting example described and shown herein, the opening 7 and the opening 8 are arranged the one next to the other along a direction orthogonal to the longitudinal axis A.

Preferably, the openings 7 and 8 are arranged so that the passage of material through them occurs along respective directions F7 and F8 substantially orthogonal to the flow direction D.

The opening 7 and the opening 8 have a width W, intended as the axial dimension, and a height H, intended as the dimension orthogonal to the width W.

Preferably, the opening 8 has a width W greater than the width W of the opening 7.

In the non-limiting example described and shown herein, the assembly 1 comprises a screw extruder 6 (schematically represented in FIG. 1) coupled to the process duct 2 to feed viscous material to the process duct 2.

The screw extruder 6 can be either single screw or twin screw (co-rotating or counter-rotating).The process duct 2 can be directly coupled to the extrusion cylinder of the screw extruder 6 or connected to the outlet from the screw extruder 6.

The material advancing in the process duct 2 is under pressure. Preferably, the material has a pressure higher than 0 and less than 80 bar in the process line 2. More preferably, the material pressure is higher than 0 and less than 10 bar and even more preferably higher than 0 and less than 2 bar.

In this way the passage of the material from the process duct 2 to the pumping device 9 is facilitated, as we will see in detail below.

If the material in the process duct 2 is under pressure, albeit light, the entry of the liquid into the pumping device 9 is in fact easier and more timely.

According to a variant not shown, the assembly 1 comprises an overpressure element arranged downstream of the process duct 2. The overpressure element can be a pump, typically a “melt” pump, or a flow restrictor.

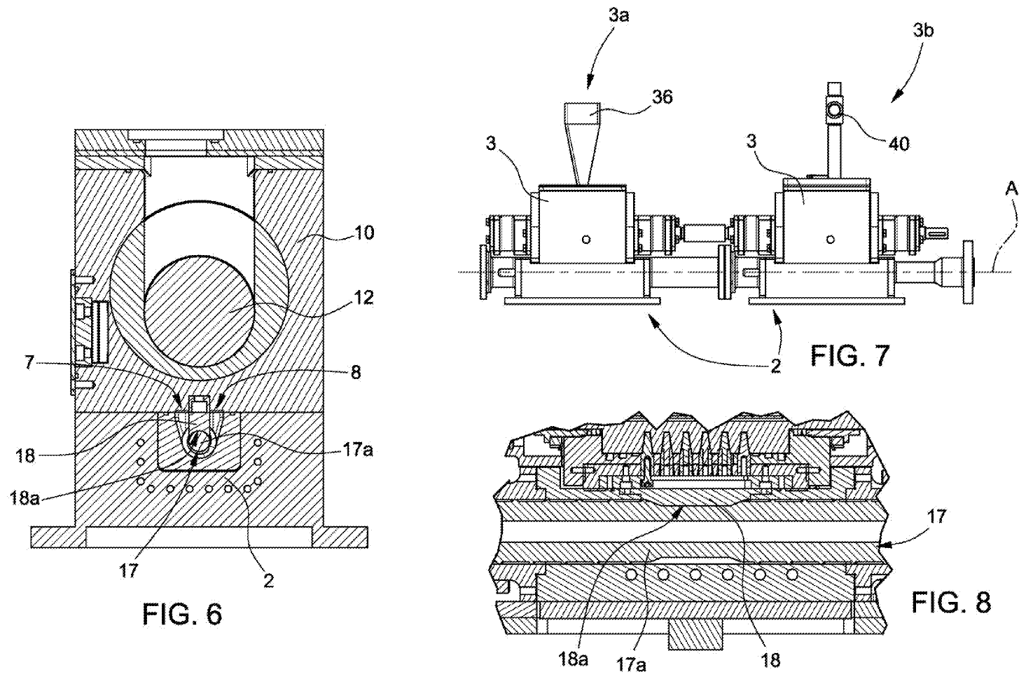

According to a variant shown in FIGS. 6 and 8, the process duct 2 houses at least one rotating extrusion screw 17 and provided with a core 17a.

In this case, the extrusion screw 17 has, in correspondence with the openings 7 and 8, a portion without thread in which only the smooth core 17a suitable for circumferential dragging (see in particular FIG. 8) is present. Preferably, in the variant of FIGS. 6 and 8, the process duct 2 is equipped with a deviating element 18, which extends from the internal surface of the process duct 2 and is substantially arranged between the openings 7 and 8. The deviating element 18 has a face 18a arranged substantially facing the core 17a of the screw 17 and almost in contact with the core 17a so as to have sufficient clearance to allow the free rotation of the core 17a. In use, the deviating element 18 contributes to forcing the material circulating in the duct 2 to travel an obligatory path around the core 17a between the openings 7 and 8.

With reference to FIGS. 1, 2 and 3, the pumping device 3 is equipped with a stator 10, comprising a cylindrical seat 11 (visible only in FIGS. 1 and 3), and with a cylindrical rotor 12 (visible only in FIGS. 1 and 3), which is housed in the cylindrical seat 11 and is coupled to the stator 10 with a sliding seal.

The rotor 12 is rotatable around an axis of rotation B substantially parallel to the longitudinal axis A and has an outer face 13 with at least one groove 15, which forms with the inner surface 16 of the cylindrical seat 11 of the stator 10 a respective pumping channel 19.

The outer face 13 of the rotor 12 and the inner cylindrical surface 16 of the stator 10 are concentric and facing each other and have respective radii of curvature so that the clearance between the rotor 12 and the stator 10 is reduced to a minimum within the tolerances that allow an easy rotation of the rotor 12 with respect to the stator 10.

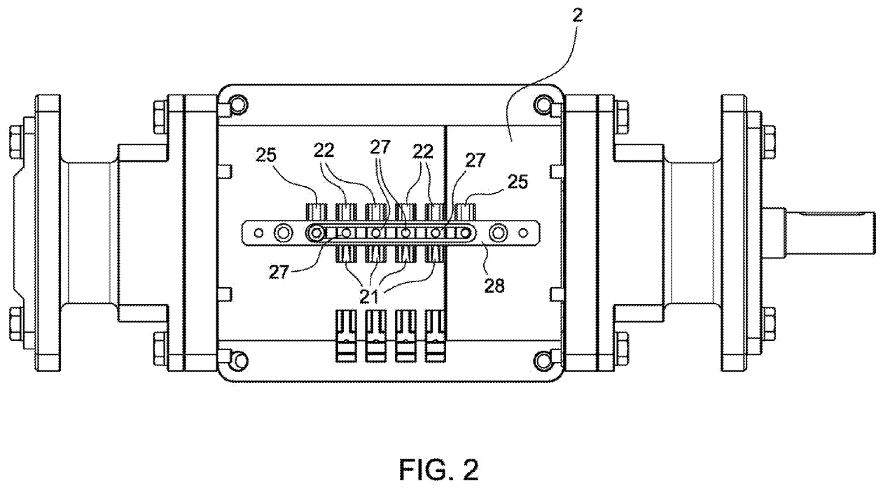

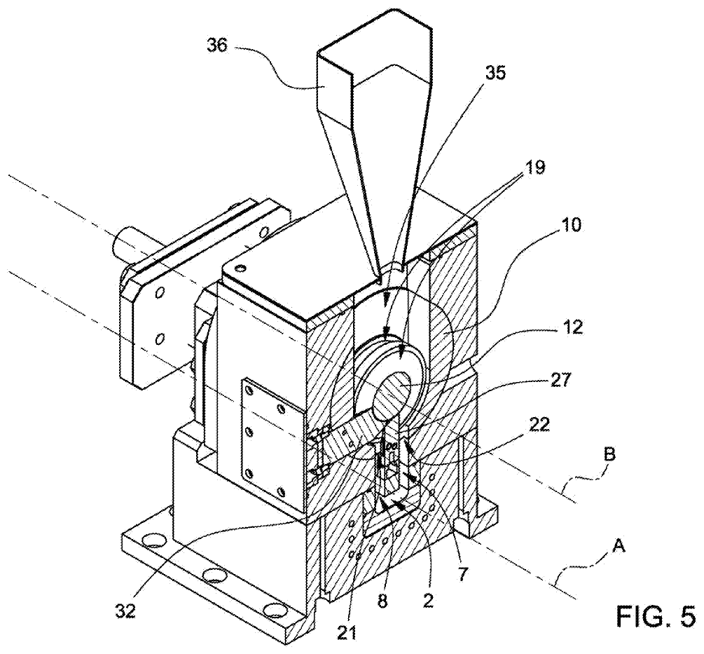

Each pumping channel 19 extends between at least one inlet 21 and at least one outlet 22 (better visible in FIGS. 2 and 5).

The inlet 21 and the outlet 22 are in fluid connection with the process duct 2. In other words, in use, the material advancing in the process duct 2 is fed to the pumping channel through the inlet 21 and is discharged in the process duct 2 through the outlet 22.

In the non-limiting example described and shown herein, the inlet 21 is in connection with the opening 7, while the outlet 22 is connection with the opening 8.

Preferably, each groove 15 extends in a circumferential direction orthogonal to the axis of rotation B, so as to define respective substantially annular pumping channels 19. In the non-limiting example described and shown herein, the outer face has six grooves, 15, four of which contribute to forming respective pumping channels 19, while the remaining two are dedicated to forming respective purge channels 24.

In particular, the pumping channels 19 are arranged between the purge channels 24.

The purge channels 24 are dedicated to the eventual venting of the material which circulates in the pumping channels 19 adjacent thereto and which reaches the purge channels 24 through the clearance space between rotor 12 and stator 10.

The purge channels 24 are connected to the opening 8 but are not connected to the opening 7. In other words, each purge channel 24 is equipped with an outlet 25 (FIG. 2) but is not equipped with an inlet in connection with the process duct 2. As already mentioned, in fact, the material enters the purge channels 24 through the clearance space between rotor 12 and stator 10.

Preferably, each pumping channel 19 is equipped with a scraper element 27 (FIG. 5) arranged in the groove 15 substantially at the outlet 22.

The scraper element 27 preferably has a profile configured to creep into the groove 15 so as to detach the material from the external face 13 of the rotor 12 and facilitate the passage of the material present in the pumping channel 19 through the outlet 22.

The scraper elements 27 of the pumping channels 19 are supported by a frame 28 connected to the stator 10 (FIG. 2).

Also each purge channel 24 is equipped with a scraper element 27 configured to creep into the groove 15 so as to detach the material from the external face 13 of the rotor 12 and facilitate the passage of the material present in the purge channel 24 through the outlet 25 of the purge channel

In this way, all the material that accidentally ends up in the purge channels 24 is introduced back into circulation in the process duct 2.

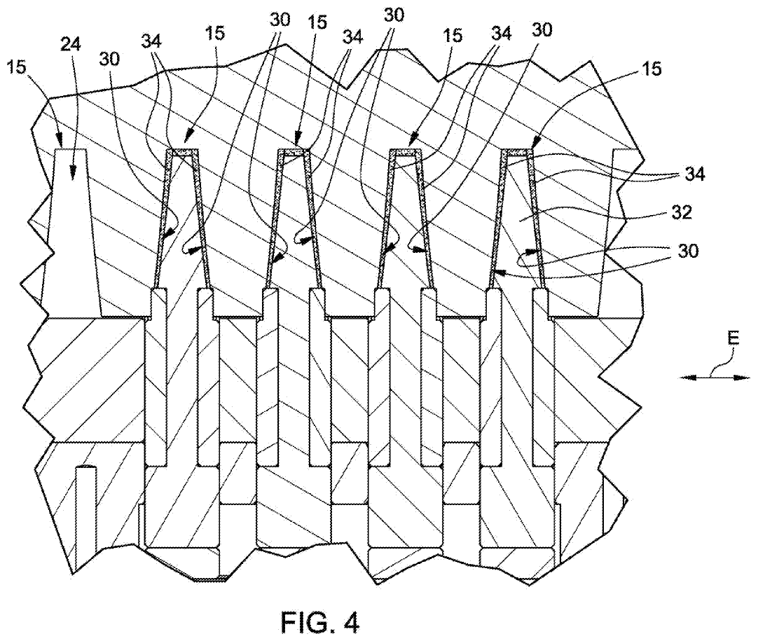

With reference to FIGS. 3 and 4, each groove 15 preferably has a diverging section towards the outside of the rotor 12. In other words, each groove 15 is equipped with diverging lateral faces 30 towards the outside of the rotor 12. It has been verified, in fact, that this geometry is more efficient than other geometries (for example rectangular) in favouring the pressurisation of the liquid material near the outlet 22.

However, it is understood that the groove 15 can also have a section of a different shape, such as for example rectangular or triangular, etc.

Preferably, at least one groove 15 houses at least a portion of a laminator element 32, which is fixed to the stator 10. The portion of the laminator element 32 that engages the groove 15 of the rotor 12 has a shape substantially complementary to the groove 15 so as to define, between the laminator element 32 and the groove 15 at least one gap 34.

In the non-limiting example described herein, the shape of the laminator element 32 is such as to define two gaps 34, each of which is defined between the laminator element 32 and the walls 30 of the groove 15.

Preferably, the gaps 34 defined by the laminator element 32 are gradually converging towards along the direction of rotation (i.e. circumferentially) starting from the inlet up to the end of the laminator element 32. In this way, at the laminator element 32, the material flows are of the elongation type thanks to the convergence of the gaps 34 along the pumping duct 19.

Preferably, the laminator element 32 is arranged in the groove 15 just downstream of the inlet 21 of the pumping channel 19.

Preferably, the laminator element 32 extends inside the groove 15 for a circumferential stretch less than the total length of the pumping channel 19. More preferably, the laminator element 32 extends inside the groove 15 for a circumferential stretch less than 25% of the total length of the pumping channel 19.

In this way, the material entering through the inlet 21 meets the laminator element 32, which is dimensioned so as to create, thanks to the presence of the gaps 34, two separate flows of material along the walls 30 of the groove 15.

In other words, the laminator element 32 increases the interface surface of the material flowing in the pumping channel 19.

Downstream of the laminator element 32, the material flows are shear-free and, under particular process conditions, they can move at the same speed of rotation as the rotor 12 without being subjected to shear stress, until there is an accumulation and pressurisation of the material near the outlet 22 of the pumping duct 19.

The circumferential length of the portion of the pumping duct 19 in which the flow is typically of the shear-free type is preferably ranging between 50° and 260°.

With reference to FIGS. 1, 2 and 5, each laminator element 32 extends along a plane transversal to the axis of rotation B.

Preferably, the laminator element 32 moves in a direction of oscillation E substantially parallel to the axis of rotation B. This allows to keep the tolerances between laminator element 32 and walls 30 substantially unchanged. In this way, the thickness of the film of material that passes through the laminator element 32 also remains unchanged and consequently the cutting speed, the elongation, and the relative stresses.

When the rotor 12 is rotating, in fact, any axial displacements of the rotor 12, mostly due to phenomena of non-homogeneous thermal expansion with the stator 10, are automatically translated to the laminator elements 32, for example by means of spacers not shown and suitably arranged, leaving the design distance between the laminator elements 32 and the walls 30 of the pumping channels 19 substantially unchanged.

Basically, thanks to the possibility of oscillation of the laminator element 32, the thickness of the separated flows downstream of the laminator element 32 remains substantially unchanged throughout the entire duration of the process.

Preferably, each laminator element 32 can oscillate along the direction E independently of the other laminator elements 32.

According to a variant not shown, a plurality of laminator elements, arranged so as to subject the material to successive laminations, are housed inside a same groove. This can lead to an increase in the dispersive effect inside the pumping channel 19.

According to a further variant, not shown, the pumping channel 19 is without laminator elements. This solution is particularly suitable for applications where it is intended to discharge a reduced stress on the material to be treated, for example in the presence of fragile fibres in the material that circulates in the pumping channel 19, such as for example glass, carbon fibres, basalt, or natural fibres, etc.

A further variant envisages that the rotor comprises pumping channels equipped with laminator elements and pumping channels without laminator elements.

Preferably, the rotor 12 is supported by two bearings 33 at the ends and is suitable for being made to rotate at very high speeds, over 1000 RPM. This speed, in relation to the diameter of the rotor 12, ranging for example between 50 and 500 mm, is equivalent to peripheral speeds ranging between approximately 0.5 and 10 m/s.

The rotor 12 is preferably fixed to a speed reducer, in turn connected to a preferably electric motor, driven by a frequency converter in order to be able to vary the speed in the range allowed by the reducer and by the frequency that can be set in the frequency converter.

With reference to FIG. 3, the stator 10 preferably has a through opening 35, which creates an aperture in at least one of the pumping channels 19.

In the non-limiting example described and shown herein, the opening 35 has the function of allowing, depending on the application, the exit of gas-air or the entry of solid additives, such as fibre powders, etc.

In other words, the opening 35 creates a discontinuity of the inner surface 16 of the stator 10, creating an aperture in the pumping channel 19, for the functions described above.

As anticipated, depending on the applications the opening 35 can be exploited in different ways.

If the assembly 1 is used for the incorporation of fillers in the material (example case shown in the attached figures), the opening 35 is connected to a loading hopper 36 through which solid particles such as powder fillers, fibres, granules, etc. are fed.

If the assembly 1 is used to degas the material or to obtain a molecular re-gradation of the material, the opening 35 is connected to a vacuum pump (not shown for simplicity's sake in the attached figures).

If the assembly 1 is used for the introduction of liquid additives or for the introduction of gas into the material, the opening 35 is connected to a source for feeding some liquid or some gas to be mixed with the material circulating in the pumping duct 19.

If the assembly 1 is used to cool the material circulating in the pumping duct 19 (for example overheated by lamination), the opening 35 is engaged by a cooling element (not shown in the attached figures) in which pressurised water or other coolant such as ethylene glycol circulate.

The viscous materials that can be processed are all thermoplastic polymers, such as, for example Polypropylene, Polyethylene, Polyamide, Polystyrene, Acrylonitrile-Butadiene-Styrene, Polysulfone, Polyimide, Polyvinyl Chloride, Polyethylene Terephthalate, Polycarbonate etc.

Furthermore, food liquids such as chocolate, etc. can also be processed.

The solid additives that can be fed through the opening 35 into the material processed in the pumping channels 19, can be, for example, mineral powders, wood flour, powders of organic substances, solid or hollow glass spheres, calcium carbonate, talc, clays, carbon black, graphite etc., nano particles such as carbon nano tubes (CNT), graphene etc., organic and inorganic pigments, titanium dioxide and in general, powders characterized by dimensions ranging between 1 nm and 10,000.00 nm, and again glass fibres, carbon, basalt, natural fibres etc.

The gases that can be fed through the opening 35 into the material processed in the pumping channels 19 can be, for example, CO2, Nitrogen, etc.

The gases that can be removed from the material processed in the pumping channels 19 are: monomeric or oligomeric residues, water vapor, reaction by-products such as oxygen, hydrogen, etc.

The products coming out of the process obtained with the apparatus of the invention can be compound in granules or finished products such as plates, tubes, profiles, films, yarns, etc.

According to a variant not shown in the attached figures, the assembly 1 can comprise at least one ON/OFF valve arranged so as to control the communication between the process duct 2 and the pumping device 3.

The assembly 1 according to the present invention is preferably equipped with a sealing system 37, which blocks the release of material at the sides of the rotor 12.

The sealing system 37 comprises the purge channels 24 already described, which receive any material released from the pumping channels 19 adjacent thereto and discharge it directly into the process duct 2.

Preferably, the sealing system 37 also comprises a viscous seal 38 defined by two grooves of the stator 10, preferably coil shaped, which are axially arranged respectively between the respective purge channel 24 and the respective bearing 33 of the rotor 12.

Preferably, the sealing system 37 also comprises two static seals 39, preferably packings, which are respectively arranged between the respective viscous seal 38 and the respective bearing 33 of the rotor 12.

According to a variant shown in FIG. 7, various pumping devices 3 configured for different applications are coupled in series to the process duct 2. In other words, the process duct 2 is equipped with a plurality of pairs of openings (not visible in FIG. 7) to which a plurality of pumping devices 3 are respectively connected.

Each pumping device 3 is arranged to carry out a specific processing. For example, a first pumping device 3a comprises the hopper 36 to carry out the introduction of powders and a second pumping device 3b comprises a vacuum pump 40 to carry out a degassing. In this way, moreover, each pumping device 3 can have more convenient dimensions and a reduced distance between the bearings. This allows to avoid bending the rotor during the process. Moreover, in this way the areas of the pumping device which operate under vacuum conditions are separated from the areas which do not operate under vacuum conditions.

With reference to FIG. 3, in use, the material fed to the process duct 2, is subjected to one or more passages through the pumping channels 19 and, after each passage, is cyclically discharged in the process duct 2.

The number of passages of a particle of material inside the pumping channel 19 is given with a good approximation by the ratio between the recirculation flow rate and the axial flow rate (Qrec/Qax).

Wherein axial flow means the flow rate fed to the process duct 2, arriving from a material pumping apparatus (for example a screw extruder 6) and recirculation flow rate means the flow rate of material that circulates in all pumping channels 19 (value depending on various variables such as geometric and operational ones such as the passage section of the pumping channel, the depth of the pumping channel, the axial distance between the walls of the pumping channel, the thickness of the material downstream of the laminator element 32 and the speed of the rotor 12).

Since the place where the processes of dispersion and surface exposure of the material take place is the pumping channel 19, it is clear that the number of passages of the material through the pumping channels 19 identifies the number of treatments to which all the material is subjected.

It is evident that a ratio Qrec/Qax<1 implies that not all the liquid has passed once through the pumping channels 19, whereas Qrec/Qax=1 implies that there has been a single passage of all the material through the pumping channels 19 and finally Qrec/Qax>1 implies that all the liquid has passed more than once through the pumping channels 19.

In greater detail, the recirculation flow rate Qrec is substantially equivalent to the volume of the material stowed in the pumping channel 19 multiplied by the rotation speed of the rotor 12 and by the number N of the pumping channels 19.

In the particular non-limiting case described and shown herein, in which the pumping channel 19 is equipped with at least one laminator element 32, the flow rate Qrec can be summarized by the following expression:

Qrec=(R²−r²)·π·N·dₘₑₗₜ·2·ω

where:
R=external radius of the pumping channel 19
r=internal pumping radius 19
N=number of pumping channels 19
dₘₑₗₜ=thickness of the layer of material downstream of the laminator element 32
ω=rotation speed of the rotor 12 (in revolutions per second)

It is known that in the processes to which the invention typically applies it is often useful to design several passages of the same material through the pumping channel 19.

In case of use of the assembly 1 according to the present invention for degassing purposes of the material, studies have shown that more than one degassing passage may be necessary for an optimal degassing. It is understood that the number of optimal passages can vary according to the applications of the assembly according to the present invention.

However, it is important to underline that, thanks to the flexibility of the present solution, it is possible to set the operation of the assembly 1 so as to obtain a desired number of passages inside the pumping device 19 in order to optimise the process for which the assembly 1 is employed.

Advantageously, the assembly and the method according to the present invention is particularly useful for producing compounds of thermoplastic material, in the form of granules or of films, sheets, plates, profiles, tubes, yarns, etc., with either compact or expanded structure.

At this point, the advantages brought by the present invention are also evident with respect to the solutions disclosed by patents GB 2007585, U.S. Pat. No. 4,606,646, WO 2019/049077, GB 1592261 and U.S. Pat. No. 4,227,816. The fact of having put an axial flow channel (2, 17) in communication with the circumferential pumping channels, each having an independent flow rate, makes it possible for the whole liquid material to pass repeatedly one or more times through the pumping channels 19 as function of the Qrec/Qax ratio. This is simply not possible with the patents mentioned.

Finally, it is evident that modifications and variations can be made to the assembly and method for processing material described herein without departing from the scope of the attached claims.

1. Assembly for processing viscous material comprising:
a process duct extending along a longitudinal axis, wherein viscous material advances in one advancing direction;
at least one pumping device provided with:
a stator comprising a cylindrical seat;
at least one cylindrical rotor, which is housed in the stator and is coupled to the stator with a sliding seal; wherein the rotor rotates around a rotating axis substantially parallel to the longitudinal axis and has an outer face with at least one groove, which forms with the inner surface of the stator at least one pumping channel;
the assembly being characterised in that the pumping device is configured so that the pumping channel extends between at least one inlet and at least one outlet; the inlet and outlet being in fluid connection with the process duct, so that, in use, the viscous material advancing in the process duct is fed to the pumping channel through the inlet and is discharged in the process duct through the outlet.

2. Assembly according to claim 1, wherein the inlet and the outlet of the pumping channel are substantially arranged side by side along a direction orthogonal to the axis of rotation.

3. Assembly according to claim 1, wherein the process duct has a first opening in connection with the input of the pumping channel and a second opening in connection with the output of the pumping channel.

4. Assembly according to claim 1, wherein the pumping channel extends in a circumferential direction orthogonal to the axis of rotation.

5. Assembly according to claim 1, wherein the pumping device comprises at least one laminator element, which is fixed to the stator and is configured to engage, at least in part, the groove of the rotor.

6. Assembly according to claim 5, wherein the portion of the laminator element that engages the groove of the rotor has a shape substantially complementary to the groove of the rotor so as to define, between the laminator element and the groove at least one gap.

7. Assembly according to claim 5, wherein the laminator element extends along a plane transversal to the axis of rotation.

8. Assembly according to claim 5, wherein the laminator element moves in a direction of oscillation substantially parallel to the axis of rotation.

9. Assembly according to claim 1, wherein the pumping device comprises a scraper element arranged in the groove substantially at the outlet; the scraper element having a profile configured to creep into the at least one groove so as to detach the material from the external face of the rotor and facilitate the passage of the material present in the pumping channel through the outlet.

10. Assembly according to claim 1, wherein at least one groove of the outer face of the rotor has a rectangular section or a diverging section towards the outside of the rotor.

11. Assembly according to claim 1, wherein the material advancing in the process duct has a pressure greater than 0 and less than 80 bar.

12. Assembly according claim 3, comprising at least one rotating extrusion screw, which is housed in the process duct

13. Assembly according to claim 12, wherein the extrusion screw has, in correspondence with the first opening and the second opening, a portion without thread; the process duct being equipped with a deviating element, which extends from the internal surface of the process duct and is substantially arranged between the first opening and the second opening.

14. Assembly according to claim 1, comprising at least one ON/OFF valve arranged so as to control the communication between the process duct and the pumping device.

15. Method for processing viscous material comprising:
feeding viscous material in one advancing direction to a process duct extending along a longitudinal axis;
fluidly connecting a pumping device with the process duct; wherein the pumping device is equipped with:
a stator comprising a cylindrical seat;
at least one cylindrical rotor, which is housed in the stator and is coupled to the stator with a sliding seal; wherein the rotor rotates around a rotating axis substantially parallel to the longitudinal axis and has an outer face with at least one groove, which forms with the inner surface of the stator a pumping channel; the pumping device being configured so that the pumping channel extends between at least one inlet and at least one outlet; the inlet and outlet being in fluid connection with the process duct.
